(19) United States
(12) Patent Application Publication
(10) Pub. No.: US 2002/0170539 A1
(43) Pub. Date: Nov. 21, 2002

(54) Fuel system

(75) Inventors: Helmut Rembold, Stuttgart (DE); Mathias Schumacher, Asperg (DE); Uwe Mueller, Hemmingen (DE); Rainer Wilms, Markgroeningen (DE)

Correspondence Address: GREIGG & GREIGG P.L.L.C., 1423 Powhatan Street, Unit One, Alexandria, VA, 22314, US

(73) Assignee: Robert Bosch GmbH

(21) Appl. No.: 10/103,813

(22) Filed: Mar. 25, 2002

(30) Foreign Application Priority Data
Mar. 28, 2001 (DE) 1 01 15 324.4

(51) Int. Cl. F02M 1/00

(52) U.S. Cl. 123/458

(57) ABSTRACT

A fuel system for supplying fuel to an internal combustion engine includes a storage tank and a first fuel pump, which is connected on the input side to the storage tank. A second fuel pump is connected on the input side to the first fuel pump via a fuel connection. The system also includes a pressure adjusting device for the output side of the second fuel pump and a pressure damping device disposed in the fuel connection between the first fuel pump and the second fuel pump. Cost of the system is reduced by a flow inhibitor, which only permits a flow in the direction of the second fuel pump, disposed in the fuel connection between the first fuel pump and the second fuel pump, close to the second fuel pump and upstream of an inlet of the pressure adjusting device in terms of the flow direction.

### FIELD OF THE INVENTION

The current invention relates to a fuel system for supplying fuel for an internal combustion engine, with a storage tank, a first fuel pump that is connected on the input side to the storage tank, a second fuel pump that is connected on the input side to the first fuel pump via a fuel connection, a pressure adjusting device for the output side of the second fuel pump, and a pressure damping device disposed in the fuel connection between the first and second fuel pump.

### DESCRIPTION OF THE PRIOR ART

A fuel system of the kind described above has been disclosed by DE 195 39 885 A1 which shows a fuel system in which a first fuel pump supplies fuel from a fuel storage tank to a second fuel pump via a fuel line. The second fuel pump is a high-pressure fuel pump driven by the engine. This high-pressure fuel pump delivers the fuel at a very high pressure into a fuel accumulation line (also known as a “rail”). From there, the fuel travels to at least one injection valve, which finally injects the fuel into the combustion chamber. Usually, the number of injection valves is equal to the number of cylinders of the engine. The fuel system can be designed so that the injection valve injects the fuel directly into a combustion chamber of the engine.

The pressure in the fuel accumulation line, i.e. the output-side pressure of the high-pressure fuel pump, is adjusted by means of a pressure adjusting device. This pressure adjusting device can, for example, be a quantity control valve, whose input side is connected to the outlet of the high-pressure fuel pump and whose output side is in turn connected to the inlet of the high-pressure fuel pump. When the quantity control valve is open, the fuel is fed from the outlet of the high-pressure fuel pump back to its input. Consequently, only a smaller quantity of fuel or even no fuel at all reaches the fuel accumulation line. The fuel connection between the first fuel pump and the high-pressure fuel pump contains a pressure damper, which usually includes a piston that is prestressed by a spring. When there is a temporary pressure increase, the piston is moved counter to the spring action and the pressure oscillation is thereby damped.

The known fuel system already functions in a very satisfactory manner. However, it would be desirable if it could be produced in a simpler, less expensive manner.

### OBJECTS AND SUMMARY OF THE INVENTION

This object is attained in accordance with the invention in a fuel system of the type mentioned at the beginning by virtue of the fact that a flow inhibitor, which only permits a flow in the direction of the second fuel pump, is disposed in the fuel connection between the first and second fuel pump, close to the second fuel pump and upstream of an inlet of the pressure adjusting device in terms of the flow direction.

It is clear that the costs for the fuel system according to the invention depend to a considerable degree on the quality of the components used. In the prior art, it was necessary for components that could withstand high pressures to be used essentially throughout the entire fuel system, i.e. even in the region between the first fuel pump and the second fuel pump, in which a lower fuel pressure (approx. 4 bar) usually prevails than in the region on the output side of the second fuel pump. This was related to the fact that it was necessary to provide for the eventuality of the pressure damper failing due to a technical malfunction.

In this instance, namely due to the delivery rate pulsations at the inlet of the second fuel pump and due to shutoff surges after each time the delivery of the second fuel pump stops, considerable pressure pulsations (up to approx. 15 bar) can also occur in the region of the fuel system between the first and second fuel pump. In order to prevent the destruction of the components and connecting elements in this region in such a case, the prior art had to use a relatively exacting, i.e. costly, connection technique.

Through the steps taken according to the invention, assurance will now be provided that even in the event of a failure of the pressure damper, no pressure pulsations, or at least not such powerful pressure pulsations, can travel from the second fuel pump into the region of the fuel system between the first fuel pump and the second fuel pump. In fact, the pressure pulsations are always accompanied by a short flow pulse, which is directed from the second fuel pump in the direction of the first fuel pump. The flow inhibitor according to the invention does not permit fuel to flow from the second fuel pump to the first fuel pump.

This assures that even in the event of a failure of the pressure damper that is usually provided, no pressure pulsations, or at least no powerful pressure pulsations, are detected upstream of the flow inhibitor. As used herein, the terms “downstream” and “upstream” relate to the standard overall flow direction, which is directed from the first fuel pump to the second fuel pump.

Since the step taken according to the invention has provided the assurance that no pressure pulsations or only slight pressure pulsations can occur in the region of the fuel system upstream of the flow inhibitor, cheaper components can be used in this region in which a relatively lower pressure overall prevails. This considerably reduces the costs for the entire fuel system. The step taken according to the invention is most effective if the flow inhibitor is integrated into the second fuel pump.

Advantageous modifications of the invention are also disclosed.

In a first modification of the fuel system according to the invention, the second fuel pump comprises a one-cylinder piston pump. A one-cylinder piston pump of this kind is usually driven directly by the engine, and the pressure pulsations generated are particularly pronounced. The step taken according to the invention therefore results in a particularly significant cost savings.

The flow inhibitor can comprise a check valve which, for example, can be embodied as a ball check valve. Such a check valve is an extremely inexpensive flow inhibitor.

A particularly preferable embodiment is the modification of the fuel system according to the invention in which a bypass fuel connection is provided, which bypasses the flow inhibitor and contains a hydraulic resistance, in particular a flow throttle. This modification is based on the following consideration:

A complete shutoff in the direction from the second fuel pump to the first fuel pump could produce a very powerful stress on the “high-pressure components”, i.e. the components downstream of the flow inhibitor. For example, these include the second fuel pump itself, the pressure adjusting device, and so on. In such a case, a pressure damper, which is also possibly provided, could be subjected to stresses that shorten its service life.

On the whole, the flow throttle provided in the modification does not completely prevent a flow from the second fuel pump to the first fuel pump, but damps it considerably. This assures that the pressure pulsations only travel into the region of the fuel system upstream of the flow inhibitor or the flow throttle in a considerably damped form. On the other hand, the throttle assures that the fuel can flow through the throttle with virtually no pressure loss in a cold starting situation.

### BRIEF DESCRIPTION OF THE DRAWINGS

The invention will be better understood and further objects and advantages thereof will become more apparent from the ensuing detailed description of preferred embodiments taken in conjunction with the drawings in which:

FIG. 1 shows a schematic block circuit diagram of a fuel system with a quantity control valve;

FIGS. 2a-2c show a schematic, sectional view of the quantity control valve from FIG. 1 in different operating states;

FIG. 3a shows a graph in which the opening states of the quantity control valve from FIG. 2 is plotted over time; and

FIG. 3b shows a graph in which the delivery volume of the quantity control valve from FIG. 2 is plotted over time.

### DESCRIPTION OF THE PREFERRED EMBODIMENTS

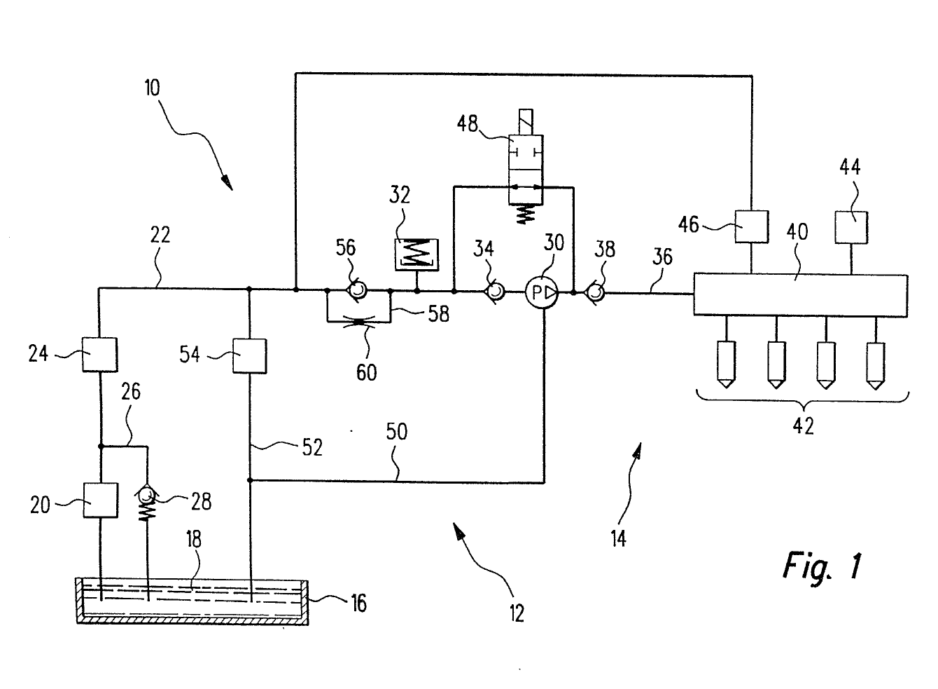

In FIG. 1, a fuel system in its entirety is labeled with the reference numeral 10. It includes a low-pressure region 12 and a high-pressure region 14.

The low-pressure region 12 contains a storage tank 16, which stores fuel 18. The fuel 18 is fed from the storage tank 16 by a first fuel pump 20. This pump is preferably an electric fuel pump which feeds into a low-pressure fuel line 22 containing a filter 24 in the vicinity of the electric fuel pump 20. Between the electric fuel pump 20 and the filter 24, a branch line 26 branches off from the low-pressure fuel line 22 and leads back to the storage tank 16. The branch line 26 contains a pressure limiting valve 28.

The low-pressure fuel line 22 leads to a second fuel pump 30, which is driven in a known manner that is not explained in detail here by the camshaft of an internal combustion engine (not shown). Upstream of the high-pressure pump 30, the low-pressure fuel line 22 also contains a pressure damper 32 and a check valve 34.

On the output side, the high-pressure pump 30 feeds into a fuel line 36, which leads via a check valve 38 to a fuel accumulation line 40, which is also referred to as the “rail”. The fuel accumulation line 40 is in turn connected to fuel injection valves 42, which inject the fuel into a combustion chamber, not shown, of the engine. A pressure sensor 44 detects the pressure in the fuel accumulation line 40. In order to prevent an overpressure in the fuel accumulation line 40, which could impair the functional efficiency of the injection valves 42, a pressure limiting valve 46 is provided in the fuel accumulation line 40. This pressure limiting valve is in turn fluid-connected to the low-pressure fuel line 22.

The pressure in the fuel line 36 and the fuel accumulation chamber 40, i.e. in the high-pressure region 14 of the fuel system 10, is controlled by means of a quantity control valve 48. The quantity control valve 48 connects the high-pressure region 14 upstream of the check valve 38 to the region of the low-pressure fuel line 22 between the check valve 34 and the pressure damper 32. A leakage line 50 leads from the high-pressure pump 30 to a branch line 52, which in turn leads to the storage tank 16. At its other end, the branch line 52 is connected to the low-pressure fuel line 22 via the pressure controller 54, which constantly maintains the pressure in the low-pressure region 12 of the fuel system 10 at a desired value.

Upstream of the pressure damper 32, the low-pressure fuel line 22 contains a flow inhibitor 56, which in this instance is embodied as a check valve. The check valve 56 only permits a flow in the direction from the electric fuel pump 20 to the high-pressure pump 30. Parallel to the check valve 56, a bypass line 58 is provided, which in turn contains a flow throttle 60.

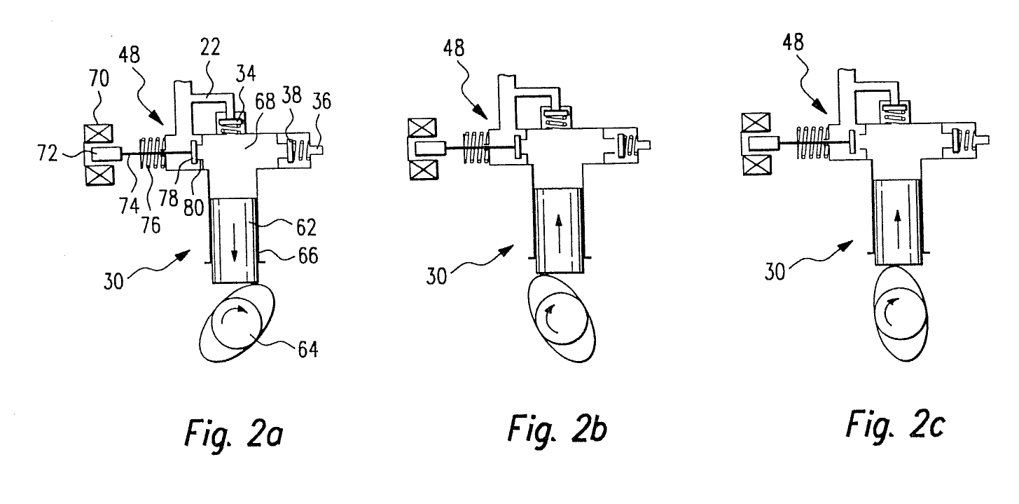

The high-pressure pump 30 is a one-piston pump. Its principal design is shown in FIGS. 2a-2c (for reasons of clarity, not all of the reference numerals are furnished in FIGS. 2b and 2c). The high-pressure pump includes a piston 62, which is moved in the axial direction by a camshaft 64 driven by the engine. The piston 62 is guided in a pump housing 66. There is a pump chamber 68 above the piston 62 in the pump housing 66.

On the inlet side, the pump chamber 68 is connected to the low-pressure fuel line 22 via the check valve 34. On the output side, the high-pressure pump 30 feeds into the high-pressure fuel line 36 via the check valve 38. The pump chamber 68 can also be connected to the low-pressure fuel line 22 by means of the quantity control valve 48. The quantity control valve 48 is a solenoid valve, whose magnet 70 acts on an armature 72, which, via a piston rod 74, can press a valve member 78 against a valve seat 80, counter to the force of a spring 76.

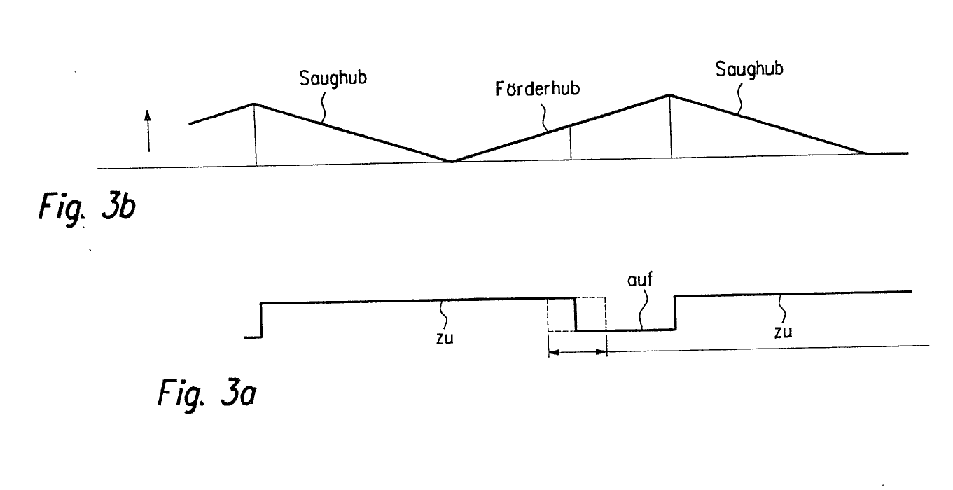

FIG. 2a shows the high-pressure pump 30 during an intake stroke. During this stroke, the piston 62 moves downward so that the pump chamber 68 is filled with fuel from the low-pressure fuel line 22 via the check valve 34. As is clearly shown in FIG. 3a, the quantity control valve 48 is closed during this intake stroke. After the end of the intake stroke, the piston 62 moves upward again (also see FIG. 3b). This is referred to as the delivery stroke (FIG. 2b). Like the quantity control valve 48, the check valve 34 is also closed. As a result, the fuel in the pump chamber 68 is compressed and is ejected into the high-pressure fuel line 36 via the check valve 38.

Based on the pressure signals supplied by the pressure sensor 44, the quantity control valve 48 is triggered by a control-and regulation unit, not shown, so that a desired pressure prevails in the fuel accumulation line 40. This occurs because the quantity control valve 48 is opened toward the end of the delivery stroke. This is shown in FIG. 2c. The compressed fuel in the pump chamber 68 can then suddenly escape into the low-pressure fuel line 22 via the quantity control valve 48. This causes a pressure surge in the low-pressure fuel line 22, which is also referred to as a “shutoff surge”. Correspondingly, a certain pressure drop in the low-pressure fuel line 22 also occurs during the intake stroke.

The pressure difference in the low-pressure fuel line 22 between the minimal pressure during the intake stroke of the high-pressure pump 30 and the maximal pressure during a shutoff surge can be up to 15 bar. Because the piston 62 of the high-pressure pump 30 moves up and down rapidly during normal operation, this causes pressure pulsations with high pressure gradients to occur in the inlet region of the high-pressure pump 30. The pressure damper 32 usually cushions these pressure pulsations. However, the design of the fuel system 10 must take into account the possibility of the pressure damper 32 no longer being able to provide the required pressure damping due to a malfunction. Both the check valve 56 and the throttle 60 are provided in order, in spite of such a malfunction, to reliably protect the components in the low-pressure region 12 of the fuel system 10 from the high pressures generated by the pressure pulsations.

The check valve 56 blocks the normal passage for the pressure oscillations in the direction of the electric fuel pump 20. Consequently, the pressure oscillations can only travel through the bypass line 58 and the throttle 60 contained in it. The pressure oscillations, however, are damped in the throttle 60. In this way, only damped pressure pulsations can travel from the high-pressure pump 30 to the components in the low-pressure region, for example the filter 24, the low-pressure regulator 54, and the electric fuel pump 20. Therefore, these components no longer need to be designed for the high pressures brought on by the pressure pulsations, and therefore can be produced at a lower cost.

At the same time, however, assurance must be provided that the electric fuel pump 20 can supply a sufficient quantity of fuel to the injection valves 52 in a cold starting situation. This is possible through an appropriate design of the throttle 60. This design is selected so that the required quantity of fuel can flow from the electric fuel pump 20, through the throttle 60, to the injection valves 42 with virtually no loss of pressure.

In order to be able to protect the entire low-pressure region 12 of the fuel system 10 as much as possible from the pressure pulsations cause by the high-pressure pump 30 in the event of a malfunctioning pressure damper 32, the check valve 56 and flow throttle 60 are preferably disposed as close as possible to the high-pressure pump 30. In an exemplary embodiment that is not shown, they are integrated directly into the connection fitting of the high-pressure pump 30.

In principle, it would also be possible for the components in the low-pressure region 12 of the fuel system 10 to be protected from excessive pressure pulsations solely by means of the check valve 56. During normal operation, however, this would subject the pressure damper 32 to very powerful stress because in such an instance, the pressure pulsations could not force any fuel at all back into the low-pressure fuel line 22. If the pressure damper 32 were to fail completely, then if only the check valve 56 were provided, the high-pressure pump 30 would be subjected to very powerful stress by the high-pressure amplitudes occurring, which could have a negative impact on its service life. Providing the bypass line 58, with the throttle 60 in it, consequently takes some of the stress off the pressure damper 32 during normal operation and in the event of a failure of the pressure damper 32, reduces the stress on the high-pressure pump 30, without otherwise exposing the components of the fuel system in the low-pressure region 12 to excessive pressure pulsations.

The foregoing relates to preferred exemplary embodiments of the invention, it being understood that other variants and embodiments thereof are possible within the spirit and scope of the invention, the latter being defined by the appended claims.

We claim:

1. A fuel system (10) for supplying fuel (18) for an internal combustion engine, comprising a storage tank (16),
a first fuel pump (20) that is connected on the input side to the storage tank (16),
a second fuel pump (30) that is connected on the input side to the first fuel pump (20) via a fuel connection (22),
a pressure adjusting device (48) for the output side of the second fuel pump (30),
a pressure damping device (32) disposed in the fuel connection (22) between the first fuel pump (20) and second fuel pump (30), and
a flow inhibitor (56), which only permits a flow in the direction of the second fuel pump (30), disposed in the fuel connection (22) between the first fuel pump (20) and second fuel pump (30), close to the second fuel pump (30) and upstream of an inlet of the pressure adjusting device (48) in terms of the flow direction.

2. The fuel system (10) according to claim 1, wherein the second fuel pump comprises a one-cylinder piston pump (30).

3. The fuel system (10) according to claim 1, wherein the flow inhibitor comprises a check valve (56).

4. The fuel system (10) according to claim 2, wherein the flow inhibitor comprises a check valve (56).

5. The fuel system (10) according to claim 1, further comprising a bypass fuel connection (58), which bypasses the flow inhibitor (56), the bypass fuel connection (58) containing a hydraulic resistance, in particular a flow throttle (60).

6. The fuel system (10) according to claim 2, further comprising a bypass fuel connection (58), which bypasses the flow inhibitor (56), the bypass fuel connection (58) containing a hydraulic resistance, in particular a flow throttle (60).

7. The fuel system (10) according to claim 3, further comprising a bypass fuel connection (58), which bypasses the flow inhibitor (56), the bypass fuel connection (58) containing a hydraulic resistance, in particular a flow throttle (60).

8. The fuel system (10) according to claim 4, further comprising a bypass fuel connection (58), which bypasses the flow inhibitor (56), the bypass fuel connection (58) containing a hydraulic resistance, in particular a flow throttle (60).
